(19) United States
(12) Patent Application Publication
(10) Pub. No.: US 2006/0231024 A1
(43) Pub. Date: Oct. 19, 2006

(54) Coating apparatus

(75) Inventors: Daisuke Takeuchi, Tokyo (JP); Yutaka Shimizu, Tokyo (JP); Kunimasa Shigehara, Tokyo (JP); Hisakazu Ijima, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/405,460

(22) Filed: Apr. 18, 2006

(30) Foreign Application Priority Data
Apr. 19, 2005 (JP) 2005-121242

(51) Int. Cl. B05C 3/12

(52) U.S. Cl. 118/420; 118/410

(57) ABSTRACT

A coating apparatus includes a backup roll that is rotated in accordance with movement of a web and supports the web from a rear surface thereof and a nozzle that includes a first edge and a second edge located at an upstream side of the first edge in a direction of movement of the web and extrudes a coating composition toward a surface of the web through a flow channel formed between the first edge and the second edge. The first edge is formed so that a corner portion between an end surface that faces the backup roll and a side surface that faces the second edge is arc-shaped in cross section and the end surface of the first edge protrudes further toward the backup roll than an end surface of the second edge that faces the backup roll.

### BACKGROUND OF THE INVENTION

1. Field of the Invention

The present invention relates to a coating apparatus equipped with a nozzle that extrudes a coating composition onto the surface of a web.

2. Description of the Related Art

The coating apparatus disclosed by Japanese Laid-Open Patent Publication No. H11-19564 is known as one example of this type of coating apparatus. The coating apparatus includes a nozzle composed of a back edge (a coating lip portion) located at a downstream side in a direction of movement of a web that moves while being supported by a backup roll and a front edge (non-coating lip portion) located at an upstream side of the back edge, and extrudes a coating composition onto the web through a flow channel formed by a space sandwiched between the two edges. In such coating apparatus, a nozzle where an end surface of the front edge that faces the backup roll is set higher than an end surface of the back edge that faces the backup roll, or a nozzle where both end surfaces have the same height is used.

However, by investigating the conventional coating apparatus described above, the present inventors found the following problem. That is, in recent years, in technical fields such as magnetic tapes, the magnetic film applied to a tape base substrate as a web is being made increasingly thin. Here, it should be obvious that the applied film needs to be formed with uniform thickness across the entire width of the web, with it also being necessary to form the applied film with uniform thickness along the entire length of the web. In a conventional coating apparatus, the end surface of the front edge of the nozzle that faces the backup roll is set higher than or the same height as the end surface of the back edge that faces the backup roll. This means that when the back edge is placed close to the web to thinly apply the coating composition onto the web, the front edge also becomes positioned close to the web. As a result, when the gap between the back edge and the web is sufficiently narrowed to make the magnetic film thinner, there is a risk of the front edge contacting the web. This means that with the conventional coating apparatus, it is not possible to make the gap between the back edge and the web sufficiently narrow, and as a result, in a state where the back edge and the web are a certain distance apart, the only way to make the applied film thinner is by accurately controlling the extruded amount of the coating composition. However, even when the supplied amount of the coating composition is accurately controlled to a small amount to make the magnetic film thinner, if the gap between the back edge and the web is wide, a wider space than is necessary for the coating composition to flow between the back edge and the web will be formed between the back edge and the web. Due to such extra space being formed, problems such as striped patterns being produced along the lengthwise direction of the web and unevenness in the thickness are occurred.

### SUMMARY OF THE INVENTION

The present invention was conceived in view of the problems described above and it is a principal object of the present invention to provide a coating apparatus capable of forming a thin and uniform applied film along the whole length of a web.

To achieve the above object, a coating apparatus according to the present invention includes: a backup roll that is rotated in accordance with movement of a web and supports the web from a rear surface thereof; and a nozzle that includes a first edge and a second edge located at an upstream side of the first edge in a direction of movement of the web and extrudes a coating composition toward a surface of the web through a flow channel formed between the first edge and the second edge, wherein the first edge is formed so that a corner portion between an end surface that faces the backup roll and a side surface that faces the second edge is arc-shaped in cross section and the end surface of the first edge protrudes further toward the backup roll than an end surface of the second edge that faces the backup roll.

According to the above coating apparatus, by forming the corner portion of the first edge between the end surface that faces the backup roll and the side surface that faces the second edge so as to be arc-shaped in cross section, the coating composition is applied to the web after flowing along the arc-shaped corner portion, and therefore the coating composition can be smoothly applied to the web. Also, by forming the end surface of the first edge that faces the backup roll so as to protrude further toward the backup roll than the end surface of the second edge that faces the backup roll, even if the first edge is positioned close to the web to thinly apply the coating composition onto the web, there is no risk of the second edge contacting the web, and therefore the first edge can be positioned sufficiently close to the web. Accordingly, the end surface of the first edge that faces the backup roll and the web can be placed only the necessary distance apart to form a space required for the coating composition to flow between the end surface and the web. This means that it is possible to reliably avoid the production of striped patterns along the lengthwise direction of the web and unevenness in the thickness due to extra space being formed between the end surface and the web. Since it is possible to form an applied film uniformly and thinly across the entire range in the length direction of the web, it is possible to make the applied film thinner.

Here, the end surface of the first edge should preferably be set to protrude further toward the backup roll than the end surface of the second edge by a distance in a range of 0.01 mm to 0.22 mm, inclusive. By using this construction, it is possible to position the first edge sufficiently close to the web and therefore to make the applied film accurately and reliably thinner.

The present application is based on Japanese Patent Application No. 2005-121242 filed on 19 Apr. 2005, the entire content of which is hereby incorporated by reference.

### BRIEF DESCRIPTION OF THE DRAWINGS

These and other objects and features of the present invention will be explained in more detail below with reference to the attached drawings, wherein:

FIG. 1 is a perspective view showing the construction of a coating apparatus;

FIG. 2 is a side view showing the positional relationship between an attached nozzle and a backup roll;

FIG. 3 is an enlarged cross-sectional view of a plane X of the coating apparatus in FIG. 1 in a state where a coating composition is being applied;

FIG. 4 is a graph showing measurement results for the thickness of an applied film produced by the coating apparatus according to the present invention; and

FIG. 5 is a graph showing measurement results for the thickness of an applied film produced by a conventional coating apparatus.

### DESCRIPTION OF THE PREFERRED EMBODTMENTS

A preferred embodiment of a coating apparatus according to the present invention will now be described with reference to the attached drawings.

First, the construction of a coating apparatus 1 will be described with reference to the drawings.

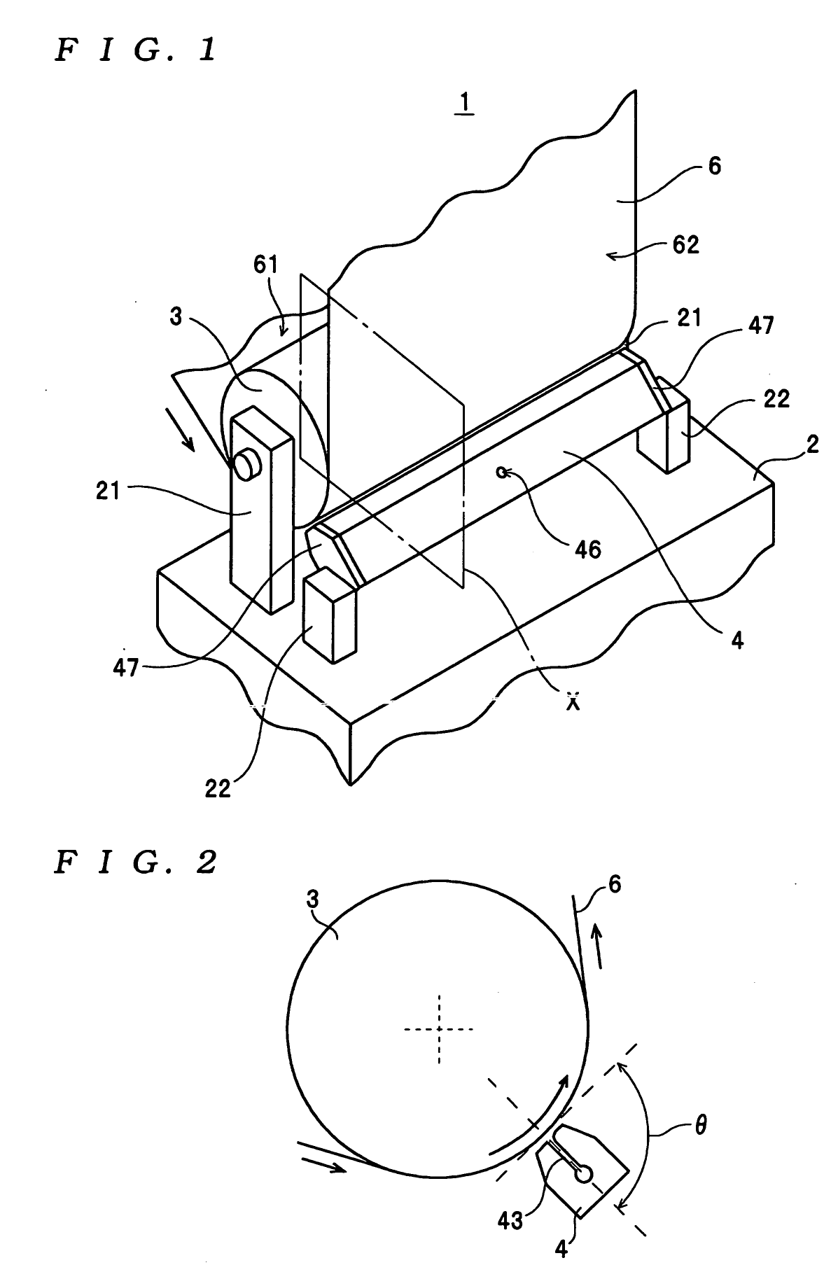

As shown in FIG. 1, the coating apparatus 1 includes a fixing stand 2, a backup roll 3, and a nozzle 4. The fixing stand 2 includes pedestals 21 that hold the backup roll 3 and pedestals 22 that fix the nozzle 4. The backup roll 3 supports a rear surface 61 of a resin film 6 (a “web” for the present invention) used as a recording medium, for example, that moves at a predetermined speed in the direction shown by the arrow in FIG. 1, and is rotated by a rotating mechanism, not shown, in accordance with movement of the resin film 6. The resin film 6 is fed out from a feeding apparatus (not shown) and is wound onto a winding apparatus (also not shown) after moving around the outer circumference of the backup roll 3.

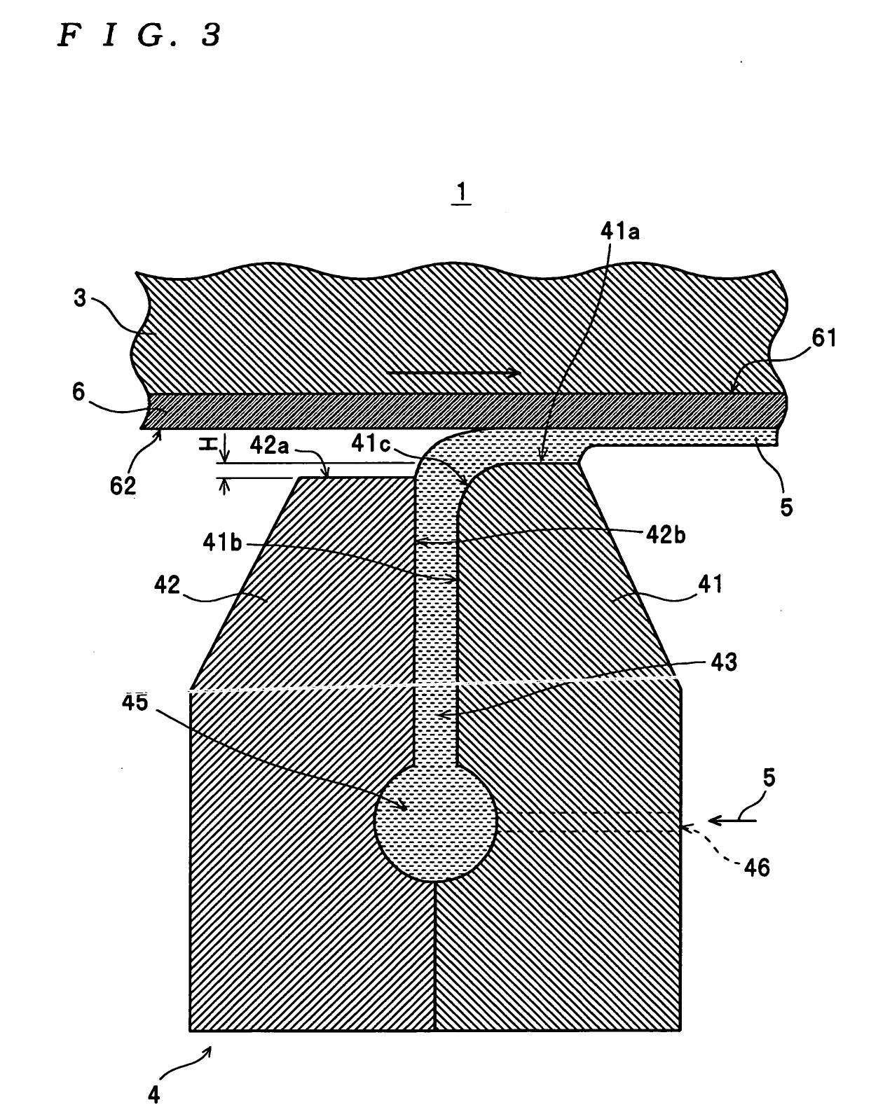

As shown in FIG. 1, the nozzle 4 is a long nozzle with a length in a lengthwise direction thereof (the widthwise direction of the resin film 6) substantially equal to the width of the resin film 6 (for example, about 800 mm), and extrudes a coating composition 5 supplied from a coating composition supplying apparatus, not shown, toward the resin film 6. Also, as shown in FIG. 3, the nozzle 4 includes a back edge 41 corresponding to a “first edge” for the present invention and a front edge 42 corresponding to a “second edge” for the present invention. In this case, the front edge 42 is located at an upstream side of the back edge 41 in the direction of movement of the resin film 6 (the direction of the arrow shown in FIG. 3). Also, the nozzle 4 extrudes the coating composition 5 toward a surface 62 of the resin film 6 through a flow channel 43 formed between the edges 41 and 42. The flow channel 43 is formed by a side surface 41b of the back edge 41 and a side surface 42b of the front edge 42 that face each other with a gap in between. Also, a pocket 45 in which the supplied coating composition 5 is temporarily reserved is formed inside the nozzle 4. The pocket 45 is formed so that the internal space is cylindrical, for example, along the widthwise direction of the nozzle 4 (the same direction as a widthwise direction of the backup roll 3) and is in communication with a coating composition supplying opening 46 for supplying the coating composition 5 from the coating composition supplying apparatus and also in communication with the flow channel 43. Here, as shown in FIG. 1, to prevent the coating composition 5 from flowing out of positions opened to both side surfaces of the nozzle 4 in the flow channel 43 and the pocket 45, side plates 47 are attached to both side surfaces of the nozzle 4. Note that the form of the internal space of the pocket 45 is not limited to being cylindrical and may be any arbitrary shape, such as a rectangular parallelepiped. As shown in FIG. 2, the nozzle 4 is inclined and fixed to the pedestals 22 while maintaining a relationship in which an angle θ formed between a line extended from the flow channel 43 of the nozzle 4 and a tangent at the point where the extended line intersects the backup roll 3 is in a range of 90°±2° (as one example, 89°).

As shown in FIG. 3, the back edge 41 is formed so that a corner portion 41c between an end surface 41a that faces the backup roll 3 and the side surface 41b that faces the front edge 42 protrudes toward the backup roll 3 and is arc-shaped in cross-section, and so that the end surface 41a protrudes further toward the backup roll 3 than an end surface 42a of the front edge 42 that faces the backup roll 3. Note that a protruding height H by which the end surface 41a of the back edge 41 protrudes further than the end surface 42a of the front edge 42 toward the backup roll 3 is set at 0.04 mm. Here, the protruding height H should preferably be set in a range of 0.01 mm to 0.22 mm, inclusive. In other words, the end surface 41a of the back edge 41 should preferably protrude further than the end surface 42a of the front edge 42 by an amount in the above range. It was confirmed that if the protruding height H is less than 0.01 mm or more than 0.22 mm, the effect of making the thickness of the coating composition 5 uniform is weakened.

Next, the overall operation of the coating apparatus 1 will be described with reference to the drawings.

When an applied film is formed on the resin film 6 using the coating apparatus 1, first, the nozzle 4 is fixed to the pedestals 22 so that the gap between the nozzle 4 and the backup roll 3 is a suitable value for the applied thickness of the coating composition 5. Here, since the end surface 41a of the back edge 41 protrudes further toward the backup roll 3 than the end surface 42a of the front edge 42, even if the back edge 41 is positioned close to the backup roll 3 (the resin film 6) to thinly apply the coating composition 5 onto the resin film 6, the front edge 42 will not contact the resin film 6. For this reason, it is possible to position the back edge 41 sufficiently close to the resin film 6. Accordingly, the end surface 41a of the back edge 41 and the resin film 6 can be positioned only the necessary distance apart to form a space required for the coating composition 5 to flow between the end surface 41a and the resin film 6. Next, the resin film 6 is fed out from the feeding apparatus and is wound onto the winding apparatus after moving around the outer circumference of the backup roll 3. By doing so, as shown in FIG. 3, the resin film 6 moves in the direction of the arrow with the rear surface 61 being supported on the backup roll 3. In this state, the coating composition supplying apparatus, not shown, is controlled and the supplying of the coating composition 5 (for example, a coating composition used as a lower non-magnetic layer of a multilayer magnetic tape) to the nozzle 4 is commenced.

As a result, by extruding the coating composition 5 through the coating composition supplying opening 46, the pocket 45, and the flow channel 43 of the nozzle 4, the coating composition 5 is extruded toward the surface 62 of the moving resin film 6. At this time, after contacting the surface 62 of the resin film 6, the coating composition 5 flows toward the end surface 41a of the back edge 41 along the corner portion 41c, which is arc-shaped in cross section, as the resin film 6 moves. Accordingly, compared to a nozzle where the corner portion is not formed so as to be arc-shaped in cross section, for example, the coating composition 5 smoothly passes the corner portion 41c and the vicinity thereof.

Next, the coating composition 5 passes through a gap between the end surface 41a of the back edge 41 and the surface 62 of the resin film 6 and is applied to the resin film 6. Since the end surface 41a of the back edge 41 and the resin film 6 are separated by only a sufficient gap for forming the space required for the coating composition 5 to flow between the end surface 41a and the resin film 6, striped patterns along the lengthwise direction of the resin film 6 and unevenness in the thickness due to extra space being formed between the end surface 41a and the resin film 6 are prevented from occurring. Next, the resin film 6 passes inside a drying apparatus, not shown, to dry the coating composition 5 applied to the surface 62 of the resin film 6. By doing so, a lower non-magnetic layer (applied film) is formed on the surface 62 of the resin film 6. After this, the resin film 6 on which the lower non-magnetic layer has been formed on the surface 62 is successively wound onto a winding core by the winding apparatus.

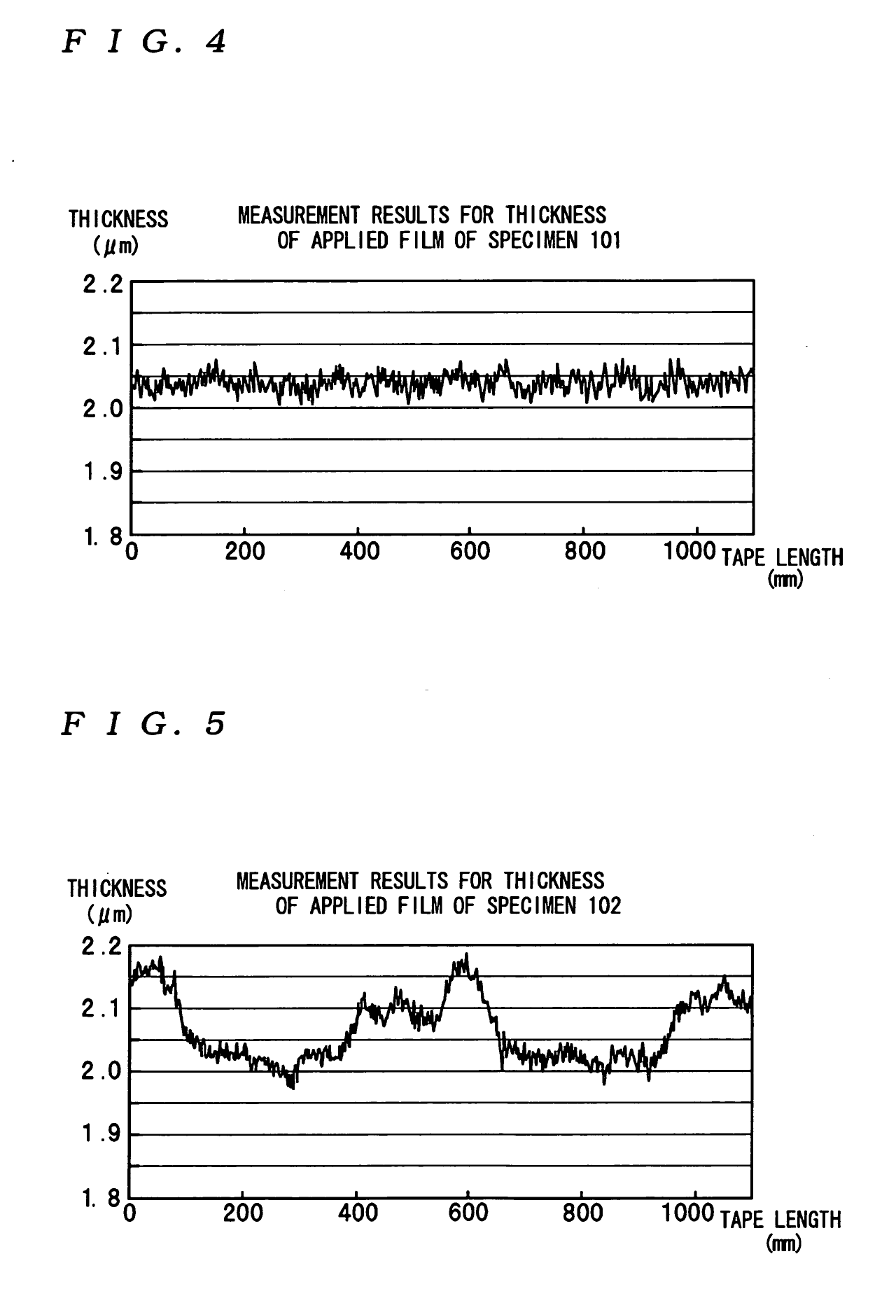

The present inventors conducted the following experiments to test the performance of the coating apparatus 1. In these experiments, the coating composition 5 for the lower non-magnetic layer of a multilayer magnetic tape was applied to the surface 62 of the resin film 6 using the nozzle 4 according to the present invention and the resulting resin film 6 was set as a specimen 101. Also, in place of the nozzle 4 according to the present invention, a nozzle where the end surface 41a of the back edge 41 and the end surface 42a of the front edge 42 have the same height (corresponding to the conventional nozzle) was used to apply the same coating composition 5 as the specimen 101 to the surface 62 of the resin film 6 and the resulting resin film 6 was set as a specimen 102 for comparison purposes. Next, the thickness of the applied film (the coating composition) in the length direction of the resin film 6 was measured for the respective specimens 101 and 102 using an X-ray film thickness gage (a 3710A model produced by RIGAKU CORPORATION). As a result, as shown in FIG. 4, on the specimen 101, the thickness of the applied film in the length direction of the resin film 6 was uniform at around 2 μm across the entire range of the applied film. On the other hand, on the specimen 102, as shown in FIG. 5, the thickness of the applied film was uneven in the length direction of the resin film 6. From the above results, it is clear that compared to a coating apparatus that uses the conventional nozzle, the coating apparatus 1 that uses the nozzle 4 according to the present invention can apply the coating composition 5 with a sufficiently uniform thickness across the entire range in the lengthwise direction of the resin film 6.

In this way, according to the coating apparatus 1, by forming the corner portion 41c of the back edge 41 between the end surface 41a that faces the backup roll 3 and the side surface 41b that faces the front edge 42 so as to be arc-shaped in cross section, the coating composition 5 is applied to the resin film 6 after flowing along the arc-shaped corner portion 41c, and therefore the coating composition 5 can be smoothly applied to the resin film 6. Also, by forming the end surface 41a of the back edge 41 that faces the backup roll 3 so as to protrude further toward the backup roll 3 than the end surface 42a of the front edge 42 that faces the backup roll 3, even if the back edge 41 is positioned close to the resin film 6 to thinly apply the coating composition 5 onto the resin film 6, there is no risk of the front edge 42 contacting the resin film 6, and therefore the back edge 41 can be positioned sufficiently close to the resin film 6. Accordingly, the end surface 41a of the back edge 41 and the resin film 6 can be placed only the necessary distance apart to form a space required for the coating composition 5 to flow between the end surface 41a and one resin film 6. This means that it is possible to reliably avoid the production of striped patterns along the lengthwise direction of the resin film 6 and unevenness in the thickness due to extra space being formed between the end surface 41a and the resin film 6. Since it is possible to form the applied film uniformly and thinly across the entire range in the lengthwise direction of the resin film 6, it is possible to make the applied film thinner.

In addition, by constructing the back edge 41 so that the end surface 41a of the back edge 41 protrudes further toward the backup roll 3 than the end surface 42a of the front edge 42 in a range of 0.01 mm to 0.22 mm, inclusive, it is possible to position the back edge 41 sufficiently close to the resin film 6 and therefore to make the applied film accurately and reliably thinner.

Note that the present invention is not limited to the construction described above. For example, although an example where the coating composition 5 is applied onto the resin film 6 for a recording medium has been described, it should be obvious that aside from the resin film 6, it is possible to apply the coating composition 5 uniformly onto various types of web using the coating apparatus 1. Although one example of the dimensions of the various parts of the nozzle 4 has been described, it is possible to freely set the dimensions of the various parts of the nozzle 4 within a range that does not depart from the scope of the present invention.

What is claimed is:

1. A coating apparatus comprising:
a backup roll that is rotated in accordance with movement of a web and supports the web from a rear surface thereof; and
a nozzle that includes a first edge and a second edge located at an upstream side of the first edge in a direction of movement of the web and extrudes a coating composition toward a surface of the web through a flow channel formed between the first edge and the second edge,
wherein the first edge is formed so that a corner portion between an end surface that faces the backup roll and a side surface that faces the second edge is arc-shaped in cross section and the end surface of the first edge protrudes further toward the backup roll than an end surface of the second edge that faces the backup roll.

2. A coating apparatus according to claim 1,
wherein the end surface of the first edge protrudes further toward the backup roll than the end surface of the second edge by a distance in a range of 0.01 mm to 0.22 mm, inclusive.
